(19) United States
(12) Patent Application Publication
(10) Pub. No.: US 2013/0311013 A1
(43) Pub. Date: Nov. 21, 2013

(54) Measurement Assisted Aerodynamic State Estimator

(71) Applicants: Philip L. ROGERS, Hume, VA (US); Elizabeth A. Dakin, Great Falls, VA (US); Priyavadan Mamidipudi, Bristow, VA (US); Daniel C. Dakin, Great Falls, VA (US)

(72) Inventors: Philip L. ROGERS, Hume, VA (US); Elizabeth A. Dakin, Great Falls, VA (US); Priyavadan Mamidipudi, Bristow, VA (US); Daniel C. Dakin, Great Falls, VA (US)

(73) Assignee: Optical Air Data Systems, LLC, Manassas, VA (US)

(21) Appl. No.: 13/473,101

(22) Filed: May 16, 2012

(51) Int. Cl. B64C 19/00

(52) U.S. Cl. 701/14

(57) ABSTRACT

An aerodynamic state estimation system includes a real-time actual measurement device, an air data computer, and a plurality of sensors. The measurement device receives laser scatter energy indicative of one or more atmospheric data parameters and outputs one or more truth measurements. The air data computer module receives the one or more truth measurements, calculates one or more state parameter estimations based on a plurality of functional parameters, and outputs at least one of the one or more truth measurements and the one or more state parameter estimations as one or more high accuracy state parameters, The plurality of sensors, located at the air data computer module, measure the plurality of functional parameters.

### BACKGROUND

1. Field of the Invention

The invention generally relates to an aerodynamic state estimator, and more specifically to a measurement assisted aerodynamic state estimator.

2. Related Art

The ability to accurately measure various flight parameters throughout an aircraft's entire flight envelope is important in terms of the safe operation of an aircraft. These various flight parameters include at least the aircraft's airspeed, its angle of attack, its angle of sideslip, and the like. Conventionally, pitot tubes and/or alpha/beta vanes are used to measure these various flight parameters. However, using only the pitot tubes and alpha/beta vanes does not provide the accuracy necessary to expand the performance capabilities of new (fly-by-wire) aircraft, and are susceptible to environmental factors causing them to adversely affect the safe operation of the aircraft.

Pitot tubes are generally configured as an elongated cylindrical tube having a relatively narrow cross-section. These pitot tubes are typically affixed to an aircraft such that a portion of the pitot tube extends outwardly from the aircraft. The pitot tubes are configured such that pressure is allowed to build up in the portion of the pitot tube that extends out from the aircraft. This buildup of pressure is caused by air that enters the pitot tube while the aircraft is in flight. The various flight parameters are calculated directly from the pressure that is built up in the pitot tube. During measurement operation, the pressure collected by the pitot tube can only travel through the pitot tube, and to an attached transducer, at the speed of sound. This is becoming problematic since more and more aircraft require active control faster than it can provide new data. For example, when traveling faster than the speed of sound, there is a delay between when the pressure is built up in the pitot tube and when the corresponding information can be utilized for actual measurements. Therefore, aircraft using pitot tubes and traveling faster than the speed of sound are finding it difficult to safely perform maneuvers because real time actual measurement can no longer be accurately obtained.

The measurement delay associated with these pitot tubes is also an issue as aircraft manufactured with higher performance capabilities, higher maneuverability, and fly-by-wire control (automated aircrafts) require stricter tolerances in their measurement time and accuracy. In particular, because modern aircraft have become more maneuverable, the aircraft needs to be able to calculate various flight parameters with higher degrees of accuracy and with shorter delays to be able to perform the necessary maneuvers. As the delay becomes longer and longer with increased speed of the aircraft, automated flight control systems responsible for adjusting the actual control surfaces of the aircraft are becoming out of phase with what the aircraft is actually doing.

In a military context, stealth capabilities are important for aircraft. These pitot tubes create a large radio cross-section as a result of a portion of the pitot tube extending outward from the aircraft, which increases radar cross-section. Therefore, aircraft designed for stealth capabilities are limited by this inherent deficiency of pitot tubes. Further, the portion of these pitot tubes that extends out from the aircraft generally creates drag, thereby resulting in the aircraft becoming less aerodynamic.

Other problems can arise from using pitot tubes. For example, pitot tubes can have calibration issues. In particular, because these pitot tubes are installed very close to the aircraft (e.g., within a boundary layer), they are adversely affected by disturbed airflow around the aircraft. Also, these pitot tubes require constant inspection to ensure that there are no leaks in the tubing. These pitot tubes also face icing issues resulting from having to fly through clouds and at high altitudes. Consequently, these pitot tubes may need to be heated at certain times to melt the ice, which in affect changes the density of the air around the pitot tube. This may also adversely affect the calibration of the pitot tubes.

As discussed above, in addition to pitot tubes, alpha/beta vanes are typically used to measure flight parameters, such as the angle of attack. These vanes are similarly inaccurate and inefficient because they also typically use pressure measurements to calculate the various flight parameters.

Therefore, aircrafts that attempt to perform state estimation using these conventional pitot tubes and/or alpha/beta vanes are rendered inefficient. In particular, due to the aforementioned deficiencies of conventional pitot tubes and alpha/beta vanes, accurate state estimation may require periodic highly accurate state parameter measurements to be taken. Performing state estimation using these conventional pitot tubes and/or alpha/beta vanes, without receiving periodic highly accurate measurements, may not be sufficiently accurate to cause a conventional Kalman filter to converge. Therefore, using only the pitot tubes and alpha/beta vanes to perform state estimation of an aircraft may not provide the necessary accuracy, and thus may adversely affect the safe operation of the aircraft.

Thus, a need exists for an aerodynamic state estimator that is capable of receiving measurement assistance to produce highly accurate state parameter measurements.

### BRIEF DESCRIPTION OF THE DRAWINGS/FIGURES

Embodiments of the invention are described with reference to the accompanying drawings. In the drawings, like reference numbers indicate identical or functionally similar elements. Additionally, the left most digit(s) of a reference number identifies the drawing in which the reference number first appears.

FIG. 1 illustrates a schematic diagram of an airborne vehicle having a measurement assisted aerodynamic state estimation system according to an exemplary embodiment of the present invention.

FIG. 2 illustrates a block diagram of a measurement assisted aerodynamic state estimation system according to an exemplary embodiment of the present invention.

FIG. 3 illustrates a graph depicting a relationship between an angle of attack and a lift coefficient according to an exemplary embodiment of the present invention.

FIG. 4 illustrates a graph depicting a relationship between an error in an angle of attack and a time constraint according to an exemplary embodiment of the present invention.

FIG. 5 is a flowchart of exemplary operational steps of calculating aerodynamic state parameters of an aircraft according to an exemplary embodiment of the present invention.

FIG. 6 is a flowchart of exemplary operational steps of determining aerodynamic aircraft data from one or more calculated aerodynamic state parameters according to an exemplary embodiment of the present invention.

Embodiments of the invention will now be described with reference to the accompanying drawings. In the drawings, like reference numbers generally indicate identical, functionally similar, and/or structurally similar elements. The drawing in which an element first appears is indicated by the leftmost digit(s) in the reference number

### DETAILED DESCRIPTION

The following Detailed Description refers to accompanying drawings to illustrate exemplary embodiments consistent with the invention. References in the Detailed Description to “one exemplary embodiment,” “an exemplary embodiment,” “an example exemplary embodiment,” etc., indicate that the exemplary embodiment described may include a particular feature, structure, or characteistic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the invention. Therefore, the Detailed Description is not meant to limit the invention. Rather, the scope of the invention is defined only in accordance with the following claims and their equivalents.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the invention. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Although the description of the present invention is to be described in terms of an optical measurement assisted aerodynamic state estimator, those skilled in the relevant art(s) will recognize that the present invention may be applicable to other device that may be capable of providing measurement assistance to the aerodynamic state estimator without departing from the spirit and scope of the present invention.

### An Exemplary Airborne Vehicle Having an Aerodynamic State Estimation System

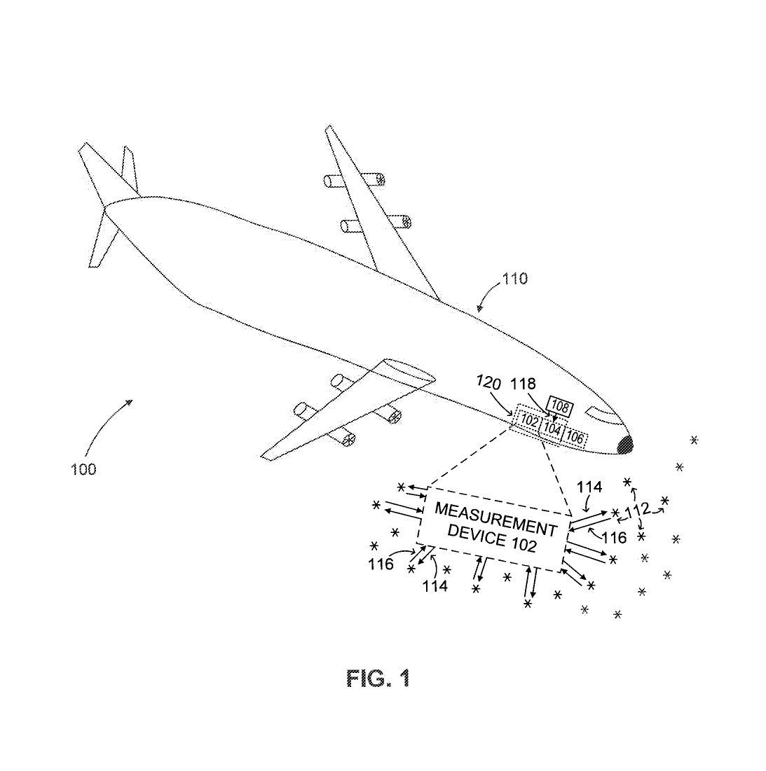

FIG. 1 illustrates a schematic diagram of an airborne vehicle 110 having a system 120 according to an exemplary embodiment of the present invention. For example, system 120 may be a measurement assisted aerodynamic state estimation system. In this example, aerodynamic state estimation system 120 includes a measurement device 102 and an air data device 104.

Aerodynamic state estimation system 120 may be implemented in any type of airborne vehicle 110, such as an aircraft 110, a commercial airliner, a military jet, a helicopter, a fly-by-wire aircraft, a zeppelin, a guided weapon system, or the like. In one example, aerodynamic state estimation system 120 may be used, for example and without limitation, to determine a state of operation of an aircraft 110.

In one example, air data device 104 may be an air data computer module 104 that includes both an air data computer and a state estimator.

In an embodiment, measurement device 102 is a real-time actual data measurement device 102 that may be an optical air data system or a mechanical system, to provide some examples; however, other systems may be possible without departing from the spirit and scope of the present disclosure. Measurement device 102 is configured to receive at least some laser scatter energy, which may include one or more laser beams 116.

In an example where system 120 is implemented in aircraft 110, system 120 is configured to generate and transmit one or more pulsed optical laser beams 114 within a vicinity or test area of aircraft 110 during flight. The pulsed beams 114 are directed to reflect off atmospheric constituents (e.g. aerosol particles) 112 in the surrounding atmosphere. The reflections produce a certain amount of laser energy scatter in the form of one or more laser beams 116. The amount of laser scatter energy produced is dependent on a scatter coefficient of the atmosphere. In one example, the scatter coefficient represents a number of atmospheric constituents 112 present in the surrounding atmosphere. The measurement device 102 receives at least some of the laser scatter energy via the one or more laser beams 116.

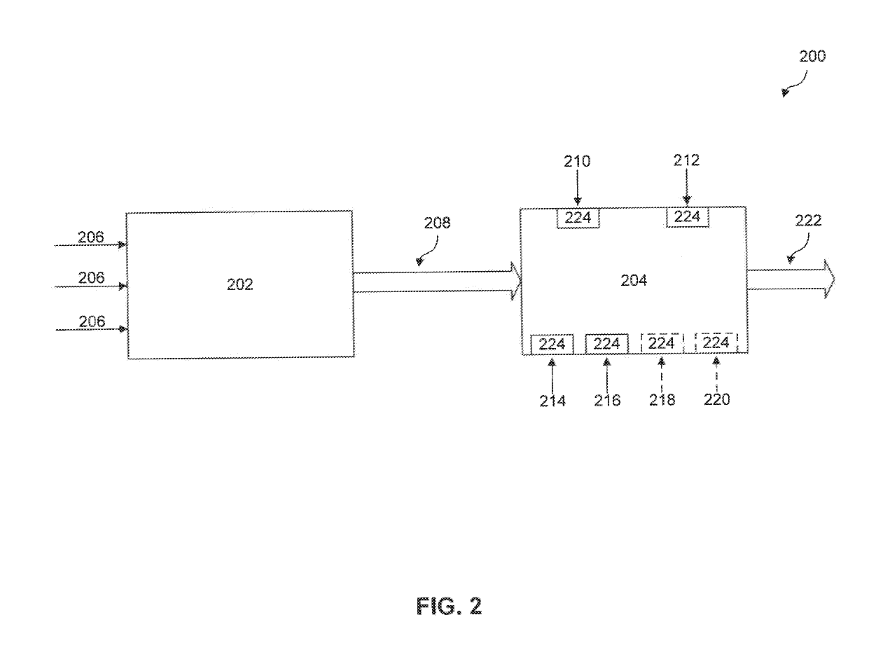

In one example, measurement device 102 produces one or more “truth measurement” data signals 208 (see FIG. 2) based on the received one or more laser beams 116. Measurement device 102 then transmits “truth measurement” data signals 208 to air data device 104. Air data device 104 is configured to either output “truth measurement” data signals 208, or one or more functional parameters to an automatic flight control system 106, which may be responsible for making the actual adjustments to current state parameters of aircraft 110.

In one example, air data device 104 may receive the functional parameters via one or more sensor ports 224 (see FIG. 2). One or more sensor ports 224 may receive actual measurement data 118 from a sensor unit 108. In an embodiment, sensor unit 108 may function substantially as described in U.S. application Ser. No. ______ filed ______, entitled “Optical Air Data System Suite of Detectors” (Atty. Doc. No. 2996.051), which is incorporated herein by reference in its entirety. In particular, sensor unit 108 may collect measurement data 118 relating to any combination of control surface position, attitude, angular rate, or acceleration of aircraft 110. In some embodiments, sensor unit 108 may also be configured to collect air temperature and air pressure of the surrounding atmosphere.

System 120, measurement device 102 and air data device 104 will be described in greater detail below, with reference to FIG. 2.

### An Exemplary Aerodynamic State Estimation System

FIG. 2 illustrates a block diagram of system 200 according to an exemplary embodiment of the present invention. System 200 may represent an exemplary embodiment of system 100, and thus system 200 may be a measurement assisted aerodynamic state estimation system 200. Aerodynamic state estimation system 200 includes measurement device 202 and an air data device 204, which may each represent exemplary embodiments of measurement device 102 and air data device 104, respectively.

In one example, measurement device 202 produces one or more “truth measurement” data signals 208 (hereinafter referred to interchangeably as signals, data, measurements, or the like) based on the received laser scatter energy 206, which as discussed above, may include one or more laser beams 116 (see FIG. 1). The use of “truth” can be understood to be, for example and without limitation, actual real-time measurements, as opposed to delayed measurements made by pitot tubes. Truth measurement signals 208 may be representative of at least one of a horizontal aircraft velocity, a vertical aircraft velocity and a lateral aircraft velocity to determine aircraft 110's (see FIG. 1) real time actual velocity. In other examples, truth measurement signals 208 may also be representative of state parameters such as the aircraft's true airspeed (TAS), angle of attack (AoA) and angle of sideslip (AoS), or any other measurements typically used to determine the real time operational status of aircraft 110. Additionally, measurement device 202 may be configured to measure parameters such as an air density and an air temperature of the surrounding atmosphere, and to output air density and air temperature parameters as a portion of one or more truth measurements 208.

In some embodiments, real-time actual measurement device 202 may periodically output one or more truth measurements 208 at intervals in the range of approximately 1 second to approximately 2 seconds, to provide an example. However, as will become apparent to those skilled in the relevant art(s), this interval range is provided for illustrative purposes only, and is not meant to limit this disclosure. In particular, an interval range that meets the requirements described herein may be used.

Conventional optical measurement devices were not able to be used for determining a state of operation of an aircraft because the scatter coefficient of the atmosphere would drop below a critical threshold for a small period of time. Similarly, as required tolerances for measured data became tighter with the advancement of high performance and highly maneuverable aircrafts, the scatter coefficient became too low for effective measurement. For example, these conditions could include a reduction in the number atmospheric constituents 112 (see FIG. 1) due to: aircraft 110 flying at high altitudes (e.g., approximately 40,000 feet and above), aircraft 110 traveling through a pocket of “clean air,” or rain temporarily washing atmospheric constituents 112 out of the air, to provide some examples. In these conditions, conventional measurement devices could not meet the new, tight tolerances required for ever advancing aircraft technology.

In one example, aerodynamic state estimation system 200 is configured to overcome the above issues using air data device 204 that operates in conjunction with measurement device 202 to compensate for temporary conditions when the scatter coefficient of the atmosphere drops below a critical threshold or when the scatter coefficient is sufficiently low so as to lower the effective measurement rate of real-time actual measurement device 202 below a minimum acceptable level. When these conditions occur, air data device 204 produces estimations for each of the state parameters addressed above until one or both of the above-noted conditions dissipate.

In one example, during the non-ideal conditions noted above, air data computer module 204 may receive one or more truth measurements 208 from real-time actual measurement device 202. For example, the horizontal, lateral, or vertical aircraft velocity. Additionally, or alternatively, the one or more truth measurements 208 can be TAS, AoA, AoS, or the like. Other exemplary inputs to air data computer module 204 can be, without limitation, an aircraft control surface position signal 210, an aircraft attitude signal 212, an aircraft angular rate signal 214, and an aircraft acceleration signal 216 (collectively referred to as functional parameters or functional parameters 210-216). In one example, the functional parameters 210-216 may be determined from other measuring systems of aircraft 110. In one example, air data computer module 204 may input functional parameters 210-216 at any predetermined measurement rate, which can be independent of the measurement rate of real-time actual measurement device 202 because each of the functional parameters 210-216 are independent of the surrounding atmospheric conditions. In some embodiments, air data computer module 204 may also be configured to input air temperature signals 218 and air pressure signals 220 of the surrounding atmosphere.

Air data computer module 204 may also be configured to calculate the TAS, AoA and AoS of aircraft 110. For example, when real-time actual measurement device 202 does not calculate the TAS, AoA, and AoS, and only outputs the horizontal, vertical, and lateral aircraft velocity, air data computer module 204 may be configured to perform the necessary calculations to determine the TAS, AoA and AoS values. For example, air data computer module 204 may be configured to perform the calculations needed to determine the TAS, AoA and AoS using a Kalman filtering technique. It is to be appreciated other techniques are possible without departing from the spirit and scope of the present disclosure. Kalman filtering as used in this disclosure refers to an algorithm which operates recursively on streams of noisy input data to produce a statistically optimal estimate of the underlying system state.

In one example, air data computer module 204 calculates and outputs one or more high accuracy state parameters 222, which represent a current state of aircraft 110. The one or more high accuracy state parameters 222 may include TAS, a calculated airspeed (CAS), AoA, AoS, a Mach number of aircraft 110, an attitude of aircraft 110, and an altitude of aircraft 110. It is to be appreciated that other state parameters are possible without departing from the spirit and scope of the present disclosure.

In one example, measurement device 202 performs the aforementioned measurements, and outputs one or more truth measurements 208, at as frequent of intervals as the surrounding atmosphere allows. Thus, a number of atmospheric constituents 112 present in the surrounding atmosphere dictate the maximum measurement rate of real-time actual measurement device 202. If a high number of atmospheric constituents 112 are present, then the amount of laser scatter energy 206 received at real-time actual measurement device 202, and the corresponding frequency with which laser scatter energy 206 may be input to real-time actual measurement device 202, is also high. The measurement rate of one or more truth measurements 208, produced by real-time actual measurement device 202, will be relatively high as well. Air data computer module 204 will then recognize, using the Kalman filtering technique, that the received one or more truth measurements 208 are accurate, and air data computer module 204 will then output one or more truth measurements 208 as high accuracy state parameters 222.

In other examples, a minimal number of atmospheric constituents 112 are present in the surrounding atmosphere (e.g., aircraft 110 is flying at a high altitude, aircraft 110 has entered a pocket of “clean air,” rain has temporarily washed atmospheric constituents 112 out of the air, or the like). The amount of laser scatter energy 206 received at real-time actual measurement device 202, and the corresponding frequency with which laser scatter energy 206 may be input to real-time actual measurement device 202, is low. For example, the low number of atmospheric constituents 112 may cause a reduced measurement rate for real-time actual measurement device 202 from approximately 30 measurements per second to approximately 10 measurements per second. Thus, the frequency at which one or more truth measurements 208 are output from real-time actual measurement device 202 is also low. When air data computer module 204 recognizes the increased time interval between receiving one or more truth measurements 208 from real-time actual measurement device 202, air data computer module 204 performs the aforementioned calculations using the Kalrnan filtering technique, or the like. The calculation produces high accuracy state parameters 222.

In one example, air data computer module 204 is configured to provide state parameter estimations as compensation for when real-time actual measurement device 202 is unable to produce one or more truth measurements 208. Air data computer module 204 is thus configured to function as both an air data computer, by performing the necessary state parameter calculations, as well as a state estimator, by producing state parameter estimations during periods of low aerosol particle 112 concentrations. The calculations of the state parameter estimations will be described in greater detail below.

In some embodiments, aerodynamic state estimation system 200 may be configured to learn aerodynamic aircraft data using a reverse estimation technique of the measurements taken by real-time actual measurement device 202 and air data computer module 204 (e.g., horizontal, vertical, and lateral aircraft velocity, or functional parameters 210-216). This reverse estimation technique would allow aerodynamic state estimation system 200 to be aircraft independent. In particular, aerodynamic state estimation system 200 could be implemented in any type of aircraft without needing a priori knowledge of specific data about the aircraft. For example, aerodynamic state estimation system 200 may be implemented without having to know the aircraft's aerodynamic properties, which may only be acquired from the aircraft manufacturer after the aircraft has been extensively tested in a wind tunnel. In an embodiment, aerodynamic state estimation system 200 may take the aforementioned measurements, and perform the corresponding calculations during a calibration flight of the aircraft.

As discussed above, real-time actual measurement device 202 may be an optical air data system, which may take the aforementioned measurements using one or more laser beams 114 and 116. Thus, these measurements can be made at the speed of light. This eliminates the time delays that were associated with conventional pitot tubes and alpha/beat vanes, which could only transmit pressure measurements at the speed of sound. As a result, aerodynamic state estimation system 200 may be implemented in even the most high performance and highly maneuverable aircrafts. This is particularly important when implementing aerodynamic state estimation system 200 in fly-by-wire aircrafts, where the pilot's instruments are connected to an automatic flight control system (e.g., automatic flight control system 106), which is responsible for making the actual adjustments to the aircraft control surface positions 210. In these fly-by-wire aircraft, if a measurement delay were to become too large using the conventional systems, the automatic flight control system could disassociate with aircraft 110's actual current state parameters. This could then result in the autopilot and/or pilot losing control of aircraft 110. Similarly, because aerodynamic state estimation system 200 does not base the aforementioned measurements on a collected pressure, it may be implemented in aircrafts having the capability to travel supersonically. Aerodyaamic state estimation system 200 may also be implemented in aircrafts that may travel at low rates of speed (e.g., a helicopter), and which produce only low pressure levels. Further, system 200 does not counteract the stealth nature of an aircraft or reduce its aerodynamic properties, as conventional pitot tubes had the tendency of doing.

Although real-time actual measurement device 202 and air data computer module 204 are shown as two separate elements, this for illustrative purposes only and it not meant to limit this disclosure. In particular, those skilled in the relevant art(s) will recognize that real-time actual measurement device 202 and air data computer module 204 may be implemented within a single integrated circuit (IC).

Further, although conventional pitot tubes and conventional alpha/beta vanes may be improperly construed as mechanical systems capable of being implemented as real-time actual measurement device 202, those skilled in the relevant art(s) will recognize that conventional pitot tubes and/or alpha/beta vanes may not be implemented as real-time actual measurement device 202 for high speed, stealth, aerodynamic aircraft, or the like. In particular, conventional pitot tubes and/or alpha/beta vanes do not provide the required measurement accuracy to be implemented as part of aerodynamic state estimation system 100. The specific measurement accuracy requirements will be discussed in great detail below.

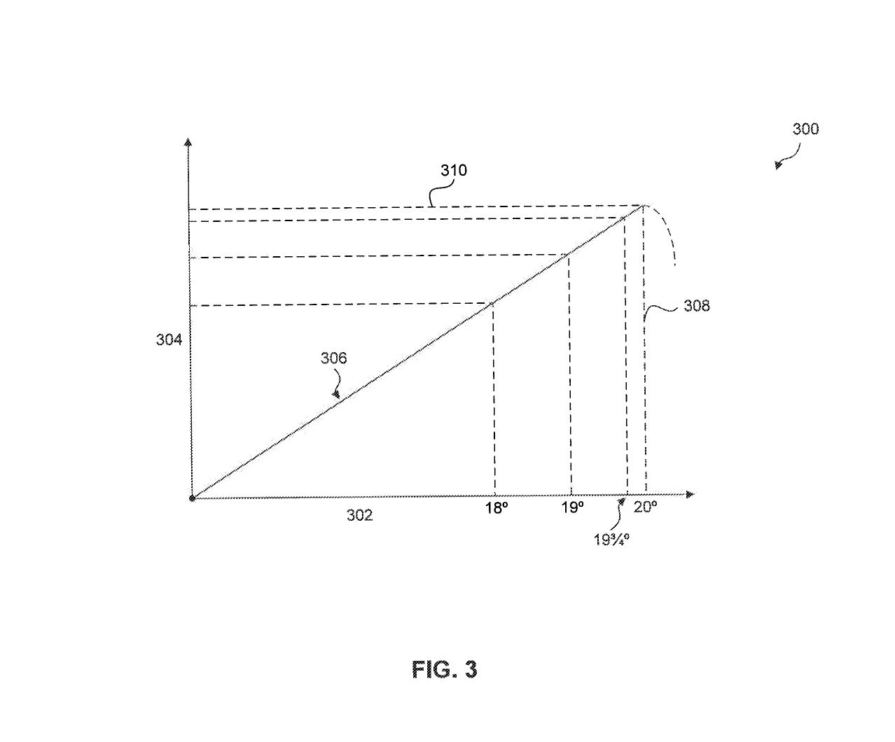

FIG. 3 illustrates a graphical representation 300 of data, according to an embodiment of the present invention. For example, the data in graph 300 can be based on air data computer module 204's (see FIG. 2) calculations of the state parameter estimations using rate gyros, accelerometers, an inertial reference system, GPS, or the like in combination with known aerodynamic parameters associated with the particular aircraft that air data computer module 204 is implemented in. The data depicted in graph 300 may then be used by system 200 (see FIG. 2) to determine aircraft 110's AoA, AoS or the like. Additionally, based on aircraft 110's acceleration, a next value may also be determined by system 200 for aircraft 110's AoA, AoS or the like.

In one example, graph 300 depicts a relationship between an angle of attack (AoA) 302 and a lift coefficient 304 according to an exemplary embodiment of the present invention is shown. AoA 302 may be represented as a linear function (e.g., line 306) of lift coefficient 304. Also, lift coefficient 304 may be calculated using the following formula: lift=½*(air density)*(aircraft velocity)²*(area of aircraft wing)*(lift coefficient 304).

As discussed with reference to FIG. 2, aerodynamic state estimation system 200 is configured to produce high accuracy state parameters 222, which may include AoA 302, AoS and the like. State parameters 222 are highly accurate because they are based, at least in part, on one or more truth measurements 208 that are periodically output from real-time actual measurement device 202. However, as also discussed above, air data computer module 204 may be required to perform state parameter estimations during periods when real-time actual measurement device 202 is unable to provide one or more truth measurements 208. Any sensor unit 108 (see FIG. 1) that may be used to measure one or more aircraft control surface position signals 210, aircraft attitude signals 212, aircraft angular rate signals 214, or aircraft acceleration signals 216, may have inaccuracies and may be subject to electronic noise. Therefore, at certain instances during aircraft 110's flight, state parameters 222 may have a relatively small amount of inaccuracy associated therewith, resulting from sensor unit 108. However, as will become apparent to those skilled in the relevant art(s), even at these instances, this small amount of inaccuracy represents a substantial improvement over the inaccuracies associated with conventional pitot tubes and alpha/beta vanes. Thus, aerodynamic estimation system 200 may be implemented in aircrafts having even the highest performance capabilities.

As discussed previously in this disclosure, conventional pitot tubes and conventional alpha/beta vanes were typically used to calculate state parameters such as AoA and AoS. However, for the reasons discussed above, both of these conventional pitot tubes and conventional alpha/beta vanes are relatively inaccurate. In particular, these conventional pitot tubes and conventional alpha/Leta vanes may be incapable of performing better than the Federal Aviation Administration's (FAA's) minimum standards for measurement accuracy for modern or advance aircraft. For example, these conventional pitot tubes and conventional alpha/beta vanes may be incapable of producing measurements that are accurate to within less than approximately 1° of an actual value. In contrast, system 200 using high accuracy state parameters 222, produced by aerodynamic state estimation system 200, may be accurate to a degree that is substantially below the FAA's minimum standards. For example, aerodynamic state estimation system 200 may produce measurements that are accurate to within approximately ⅛°. In one example, this accuracy level, e.g., ⅛°, may be adjusted up or down, even during the flight of aircraft 110, so long as the accuracy level remains below the FAA's minimum standards for measurement accuracy. In some embodiments, air data computer module 204 may be responsible for changing this accuracy level. For example, air data computer module 204 may set a higher accuracy level (e.g., ⅛°) during takeoff and landing periods, and may set a lower accuracy level (e.g., ¾°) while aircraft 110 is at a cruising altitude (e.g., when maneuverability may not be as important).

Graph 300 shows that line 306 increases linearly up until a stall AoA 308, after which point line 306 dramatically decreases. In particular, line 306 depicts that as AoA 302 increases, lift coefficient 304 also increases until AoA 302 reaches stall AoA 308. Stall AoA 308 represents the maximum angle of attack that can be achieved by aircraft 110 before aircraft 110 begins to stall. Additionally, at stall AoA 308, aircraft 110 is producing its maximum lift 310. It is desirable to have an AoA 302 that is substantially close to stall AoA 308, because this will allow aircraft 110 to takeoff in less time, takeoff using a shorter runway and to carry a larger amount of weight. In an embodiment, stall AoA 308 may be approximately 20°, to provide an example. As discussed above, conventional pitot tubes and conventional alpha/beta vanes may only produce measurements that are accurate to within approximately 1° of an actual value. Thus, these conventional pitot tubes and conventional alpha/beta vanes may incorrectly determine that the stall AoA 308 occurs at approximately 19° instead of the actual value of approximately 20°. Therefore, when utilizing these conventional pitot tubes and conventional alpha/beta vanes, AoA 302 may need to be limited to approximately 18° due to the approximately 1° of inaccuracy associated with the pitot tubes and the alpha/beta vanes. If AoA 302 was not limited to approximately 18°, then the aircraft may pitch right through stall AoA 308 because of the delay associated with these conventional pitot tubes and conventional alpha/beta vanes.

However, because aerodynamic state estimation system 200 may produce high accuracy state parameters 222 that are accurate to within approximately ⅛°, aircraft 110 having aerodynamic state estimation system 200 implemented therein may only have to limit its AoA 302 to approximately 19¾°. This difference between the maximum AoA using aerodynamic state estimation system 200 and the maximum AoA using conventional pitot tubes and conventional alpha/beta vanes may represent a substantial difference in the amount of lift that may be produced by aircraft 110. For example, this may represent the difference between aircraft 110 being able to takeoff using a 5,000 foot runway, as opposed to having to use an 8,000 foot runway, which may not exist at many of the airports around the world. Therefore, aerodynamic state estimation system 200 may allow aircraft 110 (e.g., a commercial airliner) to service almost every airport around the world. Further, depending on the weight of aircraft 110, this could also represent the difference being able to takeoff and not be able to takeoff at all. Thus, aerodynamic state estimation system 200 may allow aircraft 110 (e.g., a commercial airliner) to carry more fuel or more passengers, thereby allowing for more efficient service.

Although FIG. 3 references specific values for AoA 302 and stall AoA 308, this is for illustrative purposes only and is not meant to limit this disclosure. In particular, those skilled in the relevant art(s) will recognize that other AoA and stall AoA are possible without departing from the spirit and scope of the present disclosure. In an embodiment, graph 300 may be similarly used to show the relationship between lift coefficient 304 and AoS or the like.

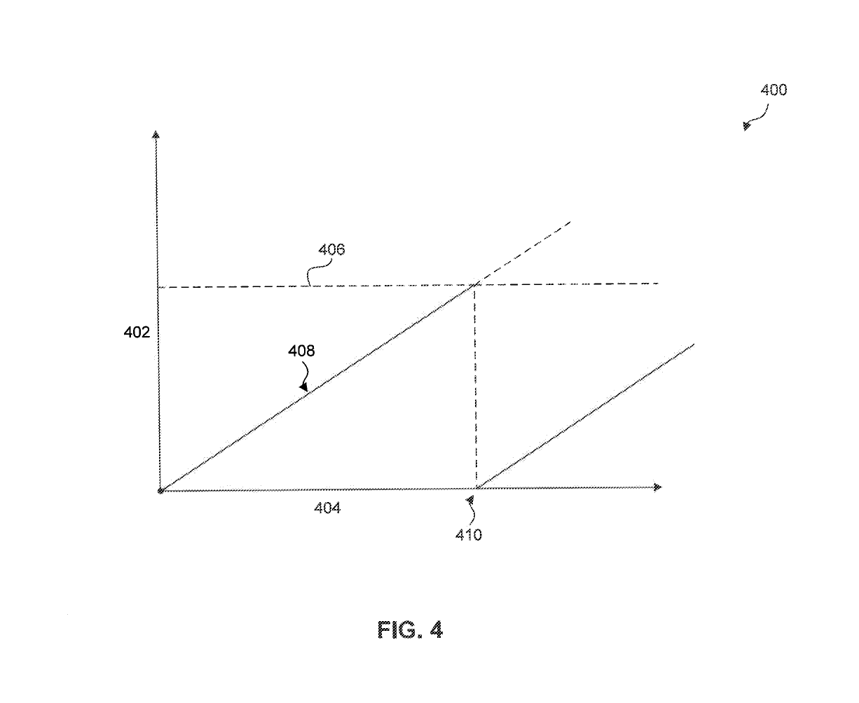

FIG. 4 illustrates a graph 400, according to an embodiment of the present invention. For example, graph 400 depicts a relationship between an error in an angle of attack (error in AoA) 402 and a time constraint 404, as well as an accuracy threshold 406 and an increase in measurement inaccuracy over time 408.

With reference again to FIGS. 1 and 2, sensor ports 224 in combination with sensor unit 108, which may be used to measure one or more aircraft control surface position signals 210, aircraft attitude signal 212, aircraft angular rate signal 214, or aircraft acceleration signal 216, may have inaccuracies and may be subject to electronic noise. Therefore, at certain periods of time during the flight of aircraft 110, state parameters 222 may have a relatively small amount of inaccuracy relating to sensor ports 224 and sensor unit 108. However, even at these instances, this small amount of inaccuracy remains below an accuracy threshold 406. In an embodiment, accuracy threshold 406 may be approximately ⅛°, to provide an example; however, other accuracy thresholds that are below the FAA minimum standards for measurement accuracy are possible without departing from the spirit and scope of the present disclosure.

Returning to FIG. 4 and continuing reference to FIG. 1, as sensor unit 108 continues to operate, the inaccuracies associated therewith begin to accumulate. This increase in inaccuracy over time is represented by line 408. Air data computer module 204 is configured to utilize functional parameters 210-216 collected by sensor ports 224 to produce state parameter estimations during periods when the scatter coefficient of the atmosphere drops below a critical threshold, or when the scatter coefficient is sufficiently low so as to lower the effective measurement rate of real-time actual measurement device 202 below a minimum acceptable level. However, because of the inaccuracies associated with sensor ports 224 and sensor unit 108, as time progresses, the state parameter estimations accumulate increasing amounts of error 402. Therefore, to ensure that the inaccuracies associated with the state parameter estimations remain below accuracy threshold 406, real-time actual measurement device 202 supplies one or more truth measurements 208 to air data computer module 204, such that error 402 associated with state parameters 222 is reset to zero.

For example, air data computer module 204 may continue to output the state parameter estimations as state parameters 222, without receiving one or more truth measurements 208, until error 402 associated therewith reaches accuracy threshold 406. In particular, air data computer module 204 may continue to output the state parameter estimations without receiving one or more truth measurements 208 until at a maximum time interval 410 is reached. In some embodiments, maximum time interval 410 may be in the order of approximately several seconds. However, depending on the quality of sensor ports 224 and sensor unit 108 (e.g., the inaccuracies associated therewith), maximum time interval 410 may be increase or decrease from the above approximation. When maximum time interval 410 is reached, real-time actual measurement device 202 may then output one or more truth measurements 208. Thus, error in AoA 402 may then be reset from its current level back to zero, at which point error in AoA 402 begins to increase again until one or more truth measurements 208 are received.

In an embodiment, at all times for which error in AoA 402 is less than accuracy threshold 406, aerodynamic state estimation system 200 may not need to measure any of the atmospheric data parameters. Instead, aerodynamic state estimation system 200 may, with sufficient accuracy, rely on the state parameter estimations provided by air data computer module 204. Further, during these periods, the state parameter estimations may be fed into automatic flight control system 106, which could then be used to control a fly-by-wire aircraft or the like.

In some embodiments, real-time actual measurement device 202 may output one or more truth measurements 208 at any time interval that is less than maximum time interval 410. Therefore, during periods when there are a larger number of atmospheric constituents 112 in the surrounding atmosphere, real-time actual measurement device 202 may be outputting one or more truth measurements 208 at a very high rate. Thus, error in AoA 402 may remain at a level substantially lower than accuracy threshold 406. In an embodiment, graph 400 may be similarly used to show the relationship between time constraint 404 and an error in AoS, or the like.

### An Exemplary Method of Calculating Aerodynamic State Parameters

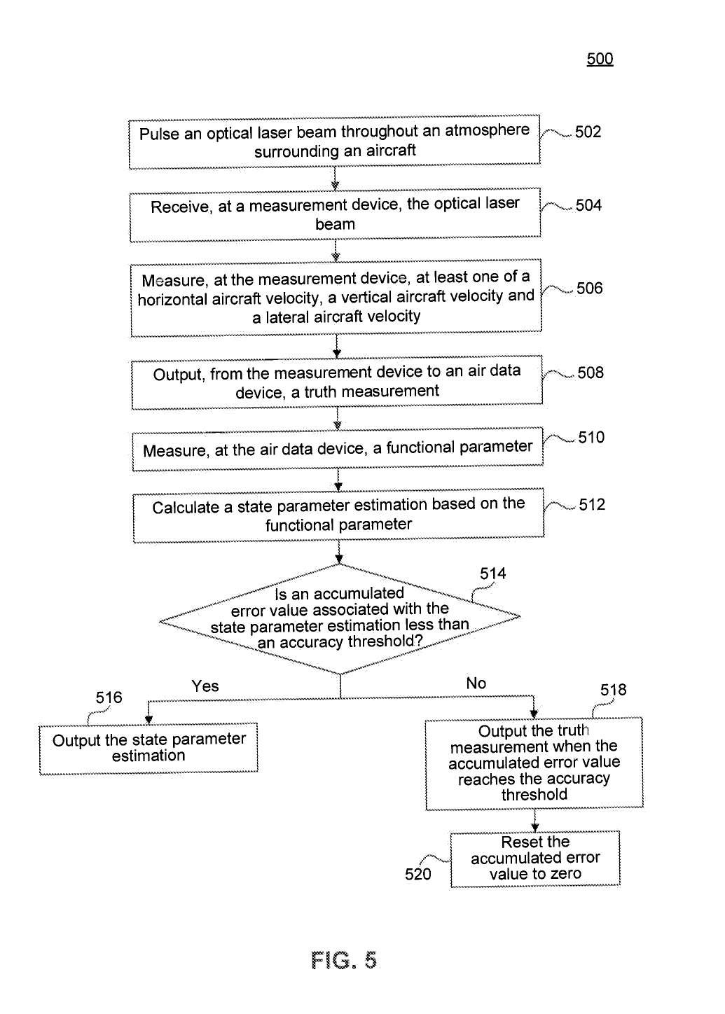

FIG. 5 is a flowchart depicting a method 500, according to an embodiment of the present invention. For example, method 500 depicts operational steps of calculating aerodynamic state parameters of an aircraft. The disclosure is not limited to this operational description. Rather, it will be apparent to persons skilled in the relevant art(s) from the teachings herein that other operational control flows are within the scope and spirit of the present disclosure. The following discussion describes the steps in FIG. 5, although not all steps are required and may be performed in a different order than shown. The flowchart of FIG. 5 is described with reference to embodiments of FIGS. 1-4. However, a method 500 is not limited to these embodiments.

In step 502, one or more pulsed optical laser beams 114 are transmitted such that the pulsed optical laser beams 114 reflect from objects in an atmosphere surrounding aircraft 110.

In step 504, the light beams 116 are received as laser scatter energy 206. Laser scatter energy 206 may represent one or more atmospheric data parameters.

In step 506, real-time actual measurement device 202 measures at least one of a horizontal aircraft velocity, a vertical aircraft velocity and a lateral aircraft velocity based on the laser beams 116 that are received as laser scatter energy 206.

In step 508, real-time actual measurement device 202 outputs one or more truth measurements 208 to air data computer module 204. For example, the one or more truth measurements 208 may include at least one of a horizontal aircraft velocity, a vertical aircraft velocity, a lateral aircraft velocity, a true airspeed (TAS), an angle of attack (AoA) and an angle of sideslip (AoS).

In step 510, air data computer module 204 measures functional parameters 210-216. Functional parameters 210-216 may include at least one of aircraft control surface position signal 210, aircraft attitude signal 212, aircraft angular rate signal 214, aircraft acceleration signal 216, air temperature signal 218 and air pressure signal 220, to provide some examples.

In step 512, air data computer module 204 calculates one or more state parameter estimations based on functional parameters 210-216.

In step 514, a decision is made as to whether an accumulated error value associated with the one or more state parameter estimations (e.g., error 402) is less than accuracy threshold 406. If the determination is yes, that the accumulated error value (e.g., error 402) is less than accuracy threshold 406, then the method proceeds to step 516. In step 516, the one or more state parameter estimations are output from air data computer module 204 as high accuracy state parameters 222.

If the decision at block 514 is no, that the accumulated error value (e.g., error 402) is not less than accuracy threshold 406, then the method proceeds to step 518. In step 518, one or more truth measurements 208 are output from air data computer module 204 as high accuracy state parameters 222, when the accumulated error (e.g., error 402) reaches the accuracy threshold 406. Accuracy threshold 406 remains below the FAA's minimum standards for measurement accuracy.

In step 520, the accumulated error value (e.g., error 402) is reset to zero when one or more truth measurements 208 are output from air data computer module 204.

An Exemplary Method of Determining Aerodynamic Aircraft Data from Calculated Aerodynamic State Parameters

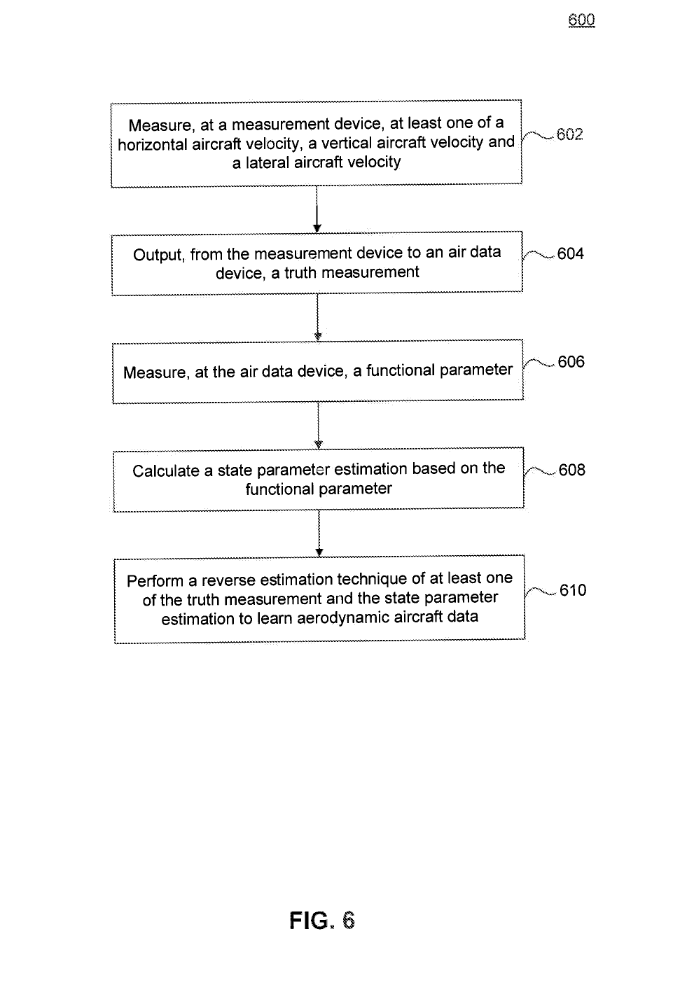

FIG. 6 is a flowchart depicting a method 600, according to an embodiment of the present invention. For example, method 600 includes exemplary operational steps of determining aerodynamic aircraft data from one or more calculated aerodynamic state parameters. The disclosure is not limited to this operational description. Rather, it will be apparent to persons skilled in the relevant art(s) from the teachings herein that other operational control flows are within the scope and spirit of the present disclosure. The following discussion describes the steps in FIG. 6, which may not all be required nor be performed in the order shown. The flowchart of FIG. 6 is described with reference to embodiments of FIGS. 1-4. However, a method 600 is not limited to these embodiments

In step 602, real-time actual measurement device 202 measures at least one of a horizontal aircraft velocity, a vertical aircraft velocity and a lateral aircraft velocity.

In step 604, real-time actual measurement device 202 outputs one or more truth measurements 208 to air data computer module 204. One or more truth measurements 208 may include at least one of a horizontal aircraft velocity, a vertical aircraft velocity, a lateral aircraft velocity, a true airspeed (TAS), an angle of attack (AoA) and an angle of sideslip (AoS), to provide some examples.

In step 606, air data computer module 204 measures functional parameters 210-216. Functional parameters 210-216 may include at least one of aircraft control surface position signal 210, aircraft attitude signal 212, aircraft angular rate signal 214, aircraft acceleration signal 216, air temperature signal 218 and air pressure signal 220, to provide some examples.

In step 608, air data computer module 204 calculates one or more state parameter estimations based on functional parameters 210-216.

In step 610, aerodynamic state estimation system 200 performs a reverse estimation technique of at least one of one or more truth measurements 208 and one or more state parameter estimations to learn aerodynamic data about the aircraft. For example, aerodynamic state estimation system 200 may be configured to learn the aerodynamic aircraft data using a reverse estimation technique of the measurements taken by real-time actual measurement device 202 and air data computer module 204 (e.g., horizontal, vertical, and lateral aircraft velocity, or functional parameters 210-216). This reverse estimation technique may allow aerodynamic state estimation system 200 to be aircraft independent. In particular, aerodynamic state estimation system 200 may then be implemented in any type of aircraft without needing a priori knowledge of specific aerodynamic aircraft data.

It is to be appreciated that the Detailed Description section, and not the Abstract section, is intended to be used to interpret the claims. The Abstract section may set forth one or more, but not all exemplary embodiments, of the invention, and thus, are not intended to limit the invention and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the invention. Thus the invention should not be limited by any of the above-described exemplary embodiments, but should be defined only in accordance with the following claims and their equivalents.

What is claimed is:

1. A system, comprising:
a measurement device configured to receive laser scatter energy indicative of an atmospheric data parameter and to output a truth measurement in real time;
sensors configured to measure a functional parameter and to produce a parameter signal therefrom; and
an air data device configured to receive the truth measurement and the parameter signal, to calculate a state parameter estimation, and to output at least one of the truth measurement and the state parameter estimation as a high accuracy state parameter.

2. The system of claim 1, wherein the air data device is configured to output the high accuracy state parameter to an automatic flight controller.

3. The system of claim 1, wherein the measurement device is an optical device.

4. The system of claim 1, wherein the measurement device is a mechanical device configured to produce measurements that have accuracy levels that satisfy an accuracy threshold.

5. The system of claim 1, wherein the measurement device further comprises:
a laser source configured to generate a pulsed laser beam and to direct the beam to reflect off of atmospheric constituents in a surrounding test area; and
a detector configured to detect the reflected beams and to produce a measurement signal therefrom.

6. The system of claim 1, wherein the system is integrated within an electronic functionality of an aircraft.

7. The system of claim 1, wherein the truth measurement includes at least one of a horizontal aircraft velocity, a vertical aircraft velocity, a lateral aircraft velocity, a true airspeed (TAS), an angle of attack (AoA) and an angle of sideslip (AoS).

8. The system of claim 1, wherein the state parameter estimation includes at least one of a true airspeed (TAS), a calculated airspeed (CAS), an angle of attack (AoA), an angle of sideslip (AoS), an aircraft Mach number and an aircraft attitude.

9. The system of claim 1, wherein the functional parameter includes at least one of an aircraft control surface position, an aircraft attitude, an aircraft angular rate, an aircraft acceleration, air temperature and air pressure.

10. The system of claim 1, wherein:
if an accumulated error value associated with the state parameter estimation satisfies an accuracy threshold, the air data device is configured to output the state parameter estimation, and
if the accumulated error value associated with the state parameter estimation does not satisfy the accuracy threshold, the air data computer module is configured to output the truth measurement.

11. The system of claim 10, wherein the accumulated error value is reset to zero when the air data device outputs the truth measurement.

12. The system of claim 10, wherein the accuracy threshold is more restrictive than a minimum standard for measurement accuracy for the Federal Aviation Administration (FAA).

13. The system of claim 10, wherein the measurement device is further configured to output the truth measurement at a measurement rate such that the accumulated error value continues to satisfy the accuracy threshold.

14. The system of claim 1, wherein the air data device is further configured to determine aerodynamic aircraft data using a reverse estimation technique of at least one of the truth measurement and the state parameter estimation.

15. The system of claim 1, wherein the measurement device is further configured to calculate at least one of a true airspeed (TAS), an angle of attack (AoA) and an angle of sideslip (AoS) based on at least one of a horizontal aircraft velocity, a vertical aircraft velocity, and a lateral aircraft velocity.

16. A method, comprising:
pulsing an optical laser beam throughout an atmosphere surrounding an aircraft such that the optical laser beam reflects off of a plurality of atmospheric constituents present in the atmosphere;
receiving, at a measurement device, the reflected beam;
measuring, at the measurement device, at least one of a horizontal aircraft velocity, a vertical aircraft velocity and a lateral aircraft velocity;
outputting, from the measurement device to an air data device, a truth measurement;
measuring, at the air data device, a functional parameter;
calculating a state parameter estimation based on the functional parameter; and
outputting at least one of the truth measurement and the state parameter estimation as a high accuracy state parameter.

17. The method of claim 16, wherein the reflected beam is indicative of an atmospheric data parameter.

18. The method of claim 16, wherein the truth measurement includes at least one of a horizontal aircraft velocity, a vertical aircraft velocity, a lateral aircraft velocity, a true airspeed (TAS), an angle of attack (AoA) and an angle of sideslip (AoS).

19. The method of claim 16, wherein the outputting at least one of the truth measurement and the state parameter estimation further compf ses:
outputting, if an accumulated error value associated with the state parameter estimation is less than an accuracy threshold, the state parameter estimation; and
outputting, if the accumulated error value associated with the state parameter estimation reaches the accuracy threshold, the truth measurement.

20. The method of claim 19, further comprising:
resetting the accumulated error value to zero when the air data device outputs the truth measurement.

21. The method of claim 19, wherein the accuracy threshold is below a minimum standard for measurement accuracy for an aircraft control system.

22. The method of claim 16, wherein the functional parameter includes at least one of an aircraft control surface position, an aircraft attitude, an aircraft angular rate, an aircraft acceleration, air temperature and air pressure.

23. The method of claim 16, further comprising:
calculating, at the measurement device, at least one of a true airspeed (TAS), an angle of attack (AoA) and an angle of sideslip (AoS) based on at least one of the horizontal aircraft velocity, the vertical aircraft velocity, the lateral aircraft velocity.

24. A method, comprising:
measuring, at a measurement device, at least one of a horizontal aircraft velocity, a vertical aircraft velocity and a lateral aircraft velocity;
outputting, from the measurement device to an air data device, a truth measurement;
measuring, at the air data device, a functional parameter;
calculating a state parameter estimation based on the functional parameter; and
performing a reverse estimation technique of at least one of the truth measurement and the state parameter estimation to determine aerodynamic aircraft data.

25. The method of claim 24, wherein the performing a reverse estimation technique is carried out without having priori knowledge of the aerodynamic aircraft data.

26. The method of claim 25, wherein the aerodynamic aircraft data includes at least wind tunnel measurement data.

27. The method of claim 24, wherein the truth measurement includes at least one of a horizontal aircraft velocity, a vertical aircraft velocity, a lateral aircraft velocity, a true airspeed (TAS), an angle of attack (AoA) and an angle of sideslip (AoS).

28. The method of claim 24, wherein the functional parameter includes at least one of an aircraft control surface position, an aircraft attitude, an aircraft angular rate, an aircraft acceleration, air temperature and air pressure.

29. The method of claim 24, wherein the measuring at least one of the horizontal aircraft velocity, the vertical aircraft velocity and the lateral aircraft velocity is performed using one or more optical laser beams.

30. The method of claim 24, further comprising:
calculating, at the measurement device, at least one of a true airspeed (TAS), an angle of attack (AoA) and an angle of sideslip (AoS) based on at least one of the horizontal aircraft velocity, the vertical aircraft velocity, the lateral aircraft velocity.
